(19) United States
(12) Patent Application Publication
(10) Pub. No.: US 2009/0248950 A1
(43) Pub. Date: Oct. 1, 2009

(54) USER DATA PROTECTION METHOD IN SERVER APPARATUS, SERVER APPARATUS AND COMPUTER PROGRAM

(76) Inventors: Masaru TAMAKI, Yokohama (JP); Akira Kato, Yokohama (JP); Kazuo Horikawa, Yokohama (JP); Yoshifumi Takamoto, Kokubunji (JP)

Correspondence Address: MATTINGLY & MALUR, P.C., 1800 DIAGONAL ROAD, SUITE 370, ALEXANDRIA, VA, 22314, US

(21) Appl. No.: 12/147,568

(22) Filed: Jun. 27, 2008

(30) Foreign Application Priority Data
Mar. 25, 2008 (JP) 2008-076950

(51) Int. Cl. G06F 12/14; G06F 12/00; G06F 21/00

(52) U.S. Cl. 711/6; 726/4; 711/163; 711/E12.001; 711/E12.092; 711/E12.091

(57) ABSTRACT

A user data protection method in which a management server includes an address replacement table having correspondence relation of memory addresses of a memory assigned to a virtual server and memory addresses of a memory assigned to a virtualization mechanism which is different from that at usual time, comprising the steps of: making, when an event occurs, the virtual server send virtual server identifier information for identifying the virtual server to the management server; making the management server detect the event; making the management server specify the virtual server in which the event occurs in accordance with the virtual server identifier information; sending the address replacement table to the virtualization mechanism of the physical server including the specified virtual server; and changing the correspondence relation of the memory addresses of the virtual server and the memory addresses of the virtualization mechanism on the basis of the address replacement table.

### INCORPORATION BY REFERENCE

The present application claims priority from Japanese application JP2008-076950 filed on Mar. 25, 2008, the content of which is hereby incorporated by reference into this application.

### BACKGROUND OF THE INVENTION

The present invention relates to a method of protecting user data in a virtual server on a virtualization mechanism, a server apparatus and a computer program.

An operating system (OS), an application program, user data and the like operating in a server apparatus are stored in a memory device provided in a server apparatus upon execution of the program. As space in which information is stored, there are mainly the kernel space in which information of the operating system is stored and the user space in which the application program and the user data are stored.

Furthermore, heretofore, as described in JP-A-2002-202901, the memory dump that information in the memory is read out to be written into a disk for the purpose of failure analysis or the like is performed.

### SUMMARY OF THE INVENTION

Recently, the capacity of the memory device is greatly increased, so that a large number of programs and data can be stored in the memory device. However, the increased capacity of the memory device causes the problem of the security. For example, heretofore, data for a program requiring a great deal of memory area as a customer information database is stored in a disk and is loaded in the memory device only when it is required, although all information in the database is stored in the memory device due to the increased memory capacity. In such circumstances, when any failure occurs and a program for reading out the contents in the memory to be written into a disk as the memory dump is executed, a great deal of user data is stored in an external storage medium such as a disk and the gotten data is transferred through a network to a support center or the disk itself is sent by mail. Accordingly, there is a problem that information is stolen through the network or the disk is lost due to trouble in mail to cause serious leakage of information.

It is an object of the present invention to protect user data stored in a memory.

According to a user data protection method of the present invention, a management server includes an address replacement table having correspondence relation of memory addresses of a memory assigned to a virtual server and memory addresses of a memory assigned to a virtualization mechanism which is different from that at usual time and the user data protection method comprises a step of making, when an event occurs, the virtual server send virtual server identifier information for identifying the virtual server to the management server, a step of making the management server detect the event, a step of making the management server specify the virtual server in which the event occurs in accordance with the virtual server identifier information when the event is detected, a step of sending the address replacement table to the virtualization mechanism of the physical server including the specified virtual server when the virtual server is specified and a step of changing the correspondence relation of the memory addresses of the virtual server and the memory addresses of the virtualization mechanism on the basis of the address replacement table.

According to the present invention, the security of the user data stored in the memory can be enhanced.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram schematically illustrating the whole configuration of a computer system according to an embodiment of the present invention;

FIG. 2 is a block diagram schematically illustrating a management server used in the computer system shown in FIG. 1;

FIG. 3 is a block diagram schematically illustrating a physical server used in the computer system shown in FIG. 1;

FIG. 4 illustrates assignment of resources to virtual servers by a virtualization mechanism;

FIG. 5 illustrates a memory map in the present invention;

FIG. 6 illustrates a memory configuration of a memory used in the computer system shown in FIG. 1;

FIG. 7 shows a physical server management table used in the management server shown in FIG. 2;

FIG. 8 shows a virtual server management table used in the management server shown in FIG. 2;

FIG. 9 shows a work load management table used in the management server shown in FIG. 2;

FIG. 10 shows a user information management table used in the management server shown in FIG. 2;

FIG. 11 shows an address replacement table used in the management server shown in FIG. 2;

FIG. 12 is a flowchart showing failure detection processing;

FIG. 13 is a flowchart showing address replacement management processing;

FIG. 14 is a flowchart showing memory registration processing;

FIG. 15 is a flowchart showing user information transmission processing;

FIG. 16 is a flowchart showing user information getting processing;

FIG. 17 is a flowchart showing memory address getting processing;

FIG. 18 is a flowchart showing address replacement processing;

FIG. 19 is a flowchart showing user information protection processing;

FIG. 20 is a flowchart showing dump getting processing;

FIG. 21 illustrates change of memory addresses;

FIG. 22 shows a virtualization mechanism address map table used in the physical server shown in FIG. 3; and

FIG. 23 shows an OS address map table used in the physical server shown in FIG. 3.

### DESCRIPTION OF THE EMBODIMENTS

Embodiments of the present invention are now described in detail with reference to the accompanying drawings.

### Embodiment 1

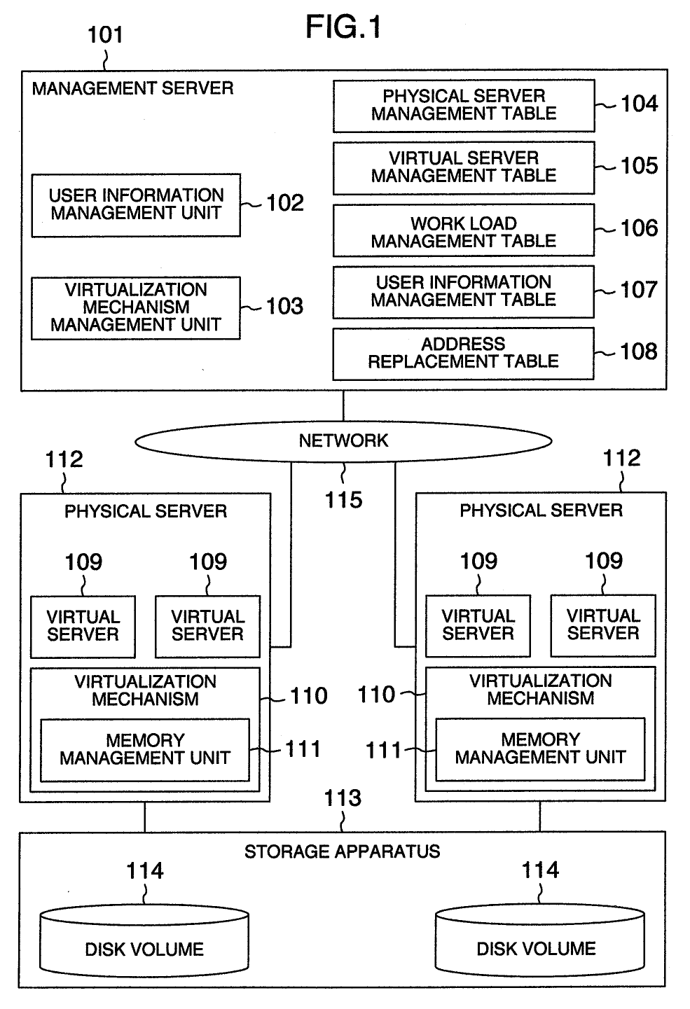

FIG. 1 is a block diagram schematically illustrating a logical system configuration of an embodiment of a computer system to which the present invention is applied.

The computer system of the embodiment includes physical servers 112 and a management server 101 connected to each other through a network 115. Each of the physical server 112 includes a virtualization mechanism 110 (capable of being realized by even a hypervisor and a virtualization program but in the embodiment described as the virtualization mechanism) and virtual servers 109 and the virtualization mechanism 110 includes a memory management unit 111. The management server 101 includes a user information management unit 102, a virtualization mechanism management unit 103, a physical server management table 104, a virtual server management table 105, a work load management table 106, a user information management table 107 and address replacement table 108. Moreover, the physical servers 112 include a storage apparatus 113 having a plurality of disk volumes 114. The storage apparatus 113 may be contained in the physical server 112 or may be an external apparatus connected through a fiber channel or the like.

The management server 101 has the function that after the management server 101 receives a protection request of information (sensitive information) which is required to be protected in a memory from a user or manager or an application in the virtual server, the management server 101 cooperates with the virtualization mechanism 110 to specify an address in which the information required to be protected is stored so that a replacement table for protecting the information is prepared. Furthermore, the management server 101 has the function of detecting failure and sends the address replacement table 108 prepared previously after detection of failure to the virtualization mechanism 110.

The user information management unit 102 has the function of calling out the virtualization mechanism management unit 103 and preparing the address replacement table 108 in order to receive the information protection request from the application 302 and specifying the address to be protected after the request is received.

The physical server management table 104 stores resource information for each of the physical servers 112 such as CPU information, disk information and memory information.

The virtual server management table 105 stores resource information assigned to each of the virtual servers 109.

The work load management table 106 stores an assignment amount and utilization rate information of CPU for each of the virtualization mechanisms 110 managed by the management server 101.

The user information management table 107 stores a memory usable range and status information for each of the virtual servers 109.

The address replacement table 108 stores information for replacing information required to be protected. Memory information registered in the address replacement table is replaced with a virtualization mechanism map table 307 at any timing, so that the information required to be protected can be protected.

The virtualization mechanism management unit 103 has the function of, in order to specify a memory address of information required to be protected, being called out by the user information management unit 102 and calling out the virtualization mechanism 110, receiving the result specified by the virtualization mechanism 110 of the memory address of information required to be protected by utilizing the virtualization mechanism address map table 307, returning the specified memory address to the user information management unit 102. Furthermore, the virtualization mechanism management unit 103 has the function of being called out by the user information management unit 102 which detects failure upon occurrence of the failure and calling out the virtualization mechanism 110 in order to overwrite information of the virtualization mechanism address map table 307 by information of the address replacement table.

In the embodiment, the application transmits the memory address of storage position information of information required to be protected to the management server 101 and prepares the address replacement table 108 from the storage position information in cooperation with the management server 101 and the virtualization mechanism 110.

There is shown an example that the data protection is realized by transferring the address replacement table 108 to the virtualization mechanism 110 upon occurrence of an event or at any timing and rewriting the memory address by the address conversion table. Holding of the storage position information of the information required to be protected and preparation of the address replacement table 108 may be performed by the hardware constructing the operating system, the virtualization mechanism 110 and the server installed in the operating system and the virtual server 109.

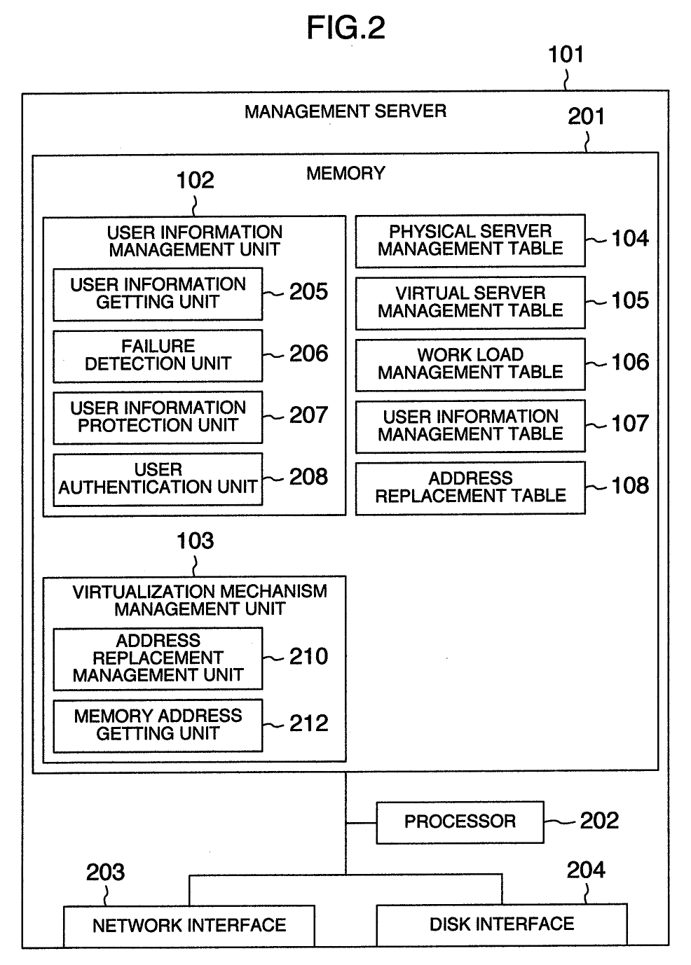

FIG. 2 is a detailed block diagram schematically illustrating the management server 101 shown in FIG. 1.

The management server 101 includes a memory 201, a processor 202, a network interface 203 and a disk interface 204.

The user information management unit 102 assigned to the memory 201 of the management server 101 is assigned or includes a user information getting unit 205, a failure detection unit 206, a user information protection unit 207 and a user authentication unit 208. The virtualization mechanism management unit 103 is assigned or includes an address replacement management unit 210 and a memory address getting unit 212.

The processor 202 executes various programs including the user information getting unit 205, the failure detection unit 206, the user information protection unit 207, the user authentication unit 208, the address replacement management unit 210 and the memory address getting unit 212 stored in the memory 201, so that each processing such as user information getting processing 1507, failure detection processing 1206, user information protection processing 1509, user authentication processing, address replacement management processing 1204 and memory address getting processing 1508 is performed. The network interface 203 is connected to the network 115 and the protection request of information required to be protected is transferred through the network interface 203.

Processings including the user information getting processing 1507, the failure detection processing 1206, the user information protection processing 1509, the user authentication processing, the address replacement management processing 1204 and the memory address getting processing 1508 are performed by executing the programs by the processor 202, although the processings may be performed in hardware constructed by forming the user information getting unit 205, the failure detection unit 206, the user information protection unit 207, the user authentication unit 208, the address replacement management unit 210 and the memory address getting unit 212 into integrated circuits as processing units for performing the processings.

The user authentication unit 208 judges whether the user has the authority of reference when a memory reference request is received from the user and when the user has the authority of reference, the user authentication unit 208 allows the user to refer to the address replacement table 108 and change it.

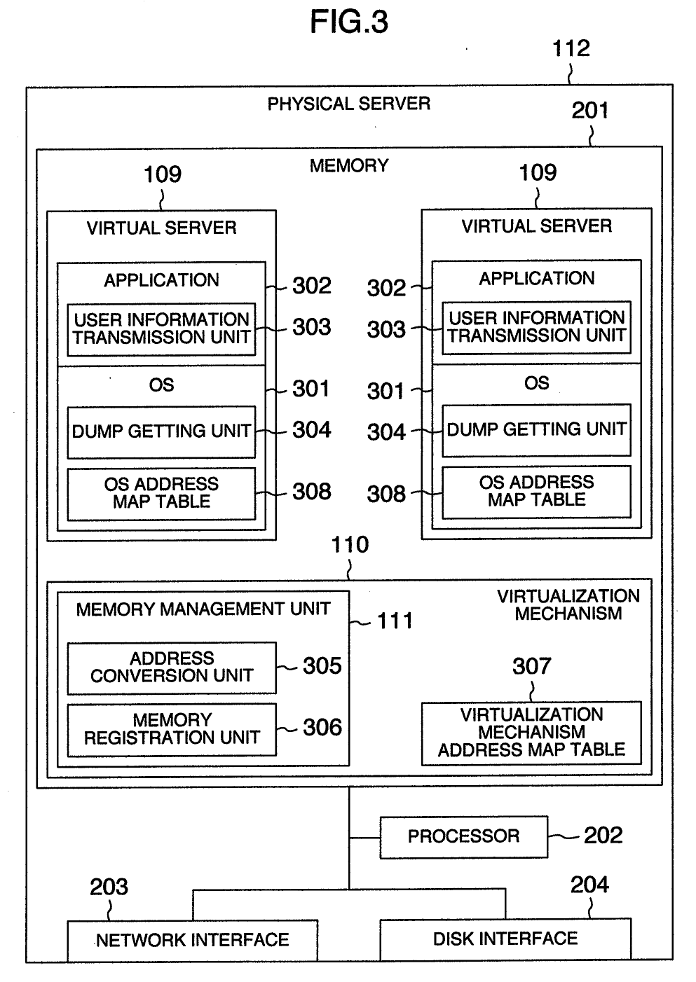

FIG. 3 is a detailed block diagram schematically illustrating the physical server 112 shown in FIG. 1.

The physical server 112 includes a memory 201, a processor 202, a network interface 203 and a disk interface 204. The memory 201 includes virtual servers 109 and a virtualization mechanism 110.

The virtual server 109 includes an operating system (OS) 301 installed therein and the operating system can be operated independently in each virtual server 109. The virtualization mechanism 110 is assigned or includes a memory management unit 111, an address conversion unit 305 and a memory registration unit 306. The virtualization mechanism 110 performs processing of dividing resources such as the memory 201 and the processor 202 to be assigned to the virtual servers 109, memory management and processing of controlling an execution schedule of the virtual servers 109.

The virtual server 109 includes an application 302 and a dump getting unit 304. Further, the application 302 includes a user information transmission unit 303.

The address conversion unit 305 has the function of referring to the virtualization mechanism address map table 307 to convert an address when an address conversion request is received from the management server 101 and transmitting the conversion result to the management server 101.

The memory registration unit 306 has the function of registering, changing and deleting the contents of the virtualization mechanism address map table 307 when a memory address registration request or a memory address replacement request is received from the management server 101.

The user information transmission unit 303 has the function of referring to an operating system address map table 308 and transmitting the address to be protected to the management server 101 when an information protection request is received.

The dump getting unit 304 has the function of writing information of the memory 201 into the disk volume 114 through the disk interface 204 in order to get failure information.

The operating system (OS) address map table 308 stores correspondence information of logical addresses and physical addresses possessed by the operating system. The physical addresses express addresses starting from the top of the memory 201 and one logical address is related to one physical address. The logical addresses are addresses for making discontinuous physical memory areas look like continuous logical memory area as viewed from the application. The software can use the discontinuous physical memory area as the continuous logical address area by using the logical addresses and accordingly utilization and management of the memory 201 are easy.

The virtualization mechanism address map table 307 stores correspondence information of virtual physical addresses, logical addresses and physical addresses possessed by the virtualization mechanism 110. The virtual physical addresses represent physical addresses of the operating system 301 operated in the virtualization mechanism 110 and are associated with the logical addresses as part of the memory included in the virtualization mechanism 110. Furthermore, since the discontinuous physical memory areas can be used as the continuous virtual address area in the same manner as above, the logical addresses and the physical addresses are stored in the virtualization mechanism address map table.

Various programs such as the address conversion unit 305, the memory registration unit 306, the user information transmission unit 303 and the dump getting unit stored in the memory 201 are executed by the processor 202, so that processings of address conversion processing 1702, memory registration processing 1404, user information transmission processing 1510 and dump getting processing 1205 are performed.

Processings including the address conversion processing 1702, the memory registration processing 1404, the user information transmission processing 1510 and the dump getting processing 1205 are performed by executing the programs by the processor 202, although the processings may be performed in hardware constructed by forming the address conversion unit 305, the memory registration unit 306, the user information transmission unit 303 and the dump getting unit 304 into integrated circuits as processing units for performing the processings.

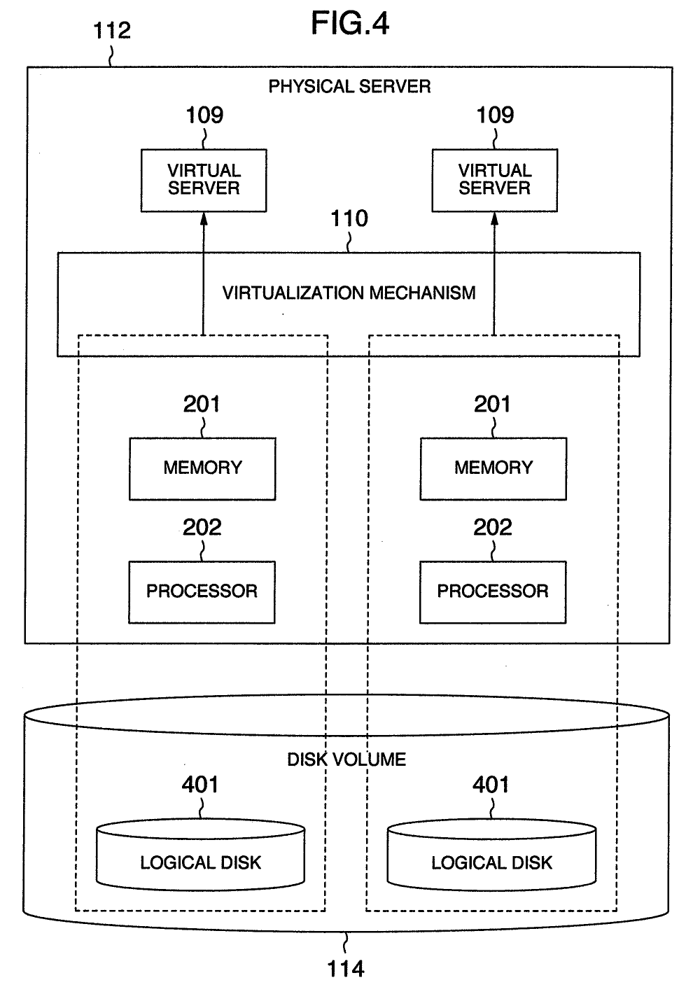

FIG. 4 is a conceptual diagram illustrating the resource assignment situation to the virtual servers 109 in the embodiment 1. The virtualization mechanism 110 assigns the memory 201 and the processor 202 provided in the physical server 112 and a logical disk 401 provided in the disk volume 114 to each of the virtual servers.

The assignment of the memory 201 means that part of the memory 201 included in the physical server 112 and managed by the virtualization mechanism 110 is assigned to the virtual server 109 as its exclusive area.

The assignment of the processor 202 means that the processor 202 is scheduled to be used by the virtual server 109 during a predetermined time.

The assignment of the logical disk 401 means that partial area of the disk volume 114 is assigned to the virtual server 109 as its exclusive area.

The memory, the processor and the logical disk use part of the physical server, although they are recognized as general memory 201, processor 202 and logical disk 401 by the operating system 301 operated on the virtual server 109.

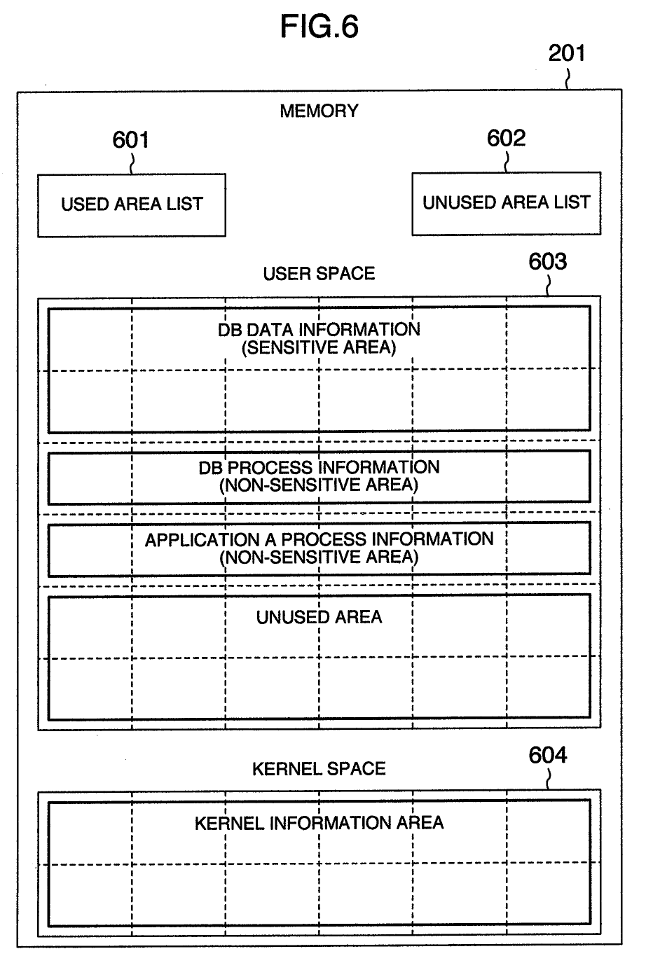

FIG. 6 is a schematic diagram illustrating the configuration and a memory map expressing the use status of the memory 201 in the embodiment 1 of the present invention.

The memory 201 includes a used area list 601, an unused area list 602, a user space 603 and a kernel space 604. The kernel space 604 is an area where programs concerning control of the operating system such as program control, memory management and disk management possessed by the operating system are stored. The user space 603 is an area where programs except control of the operating system, application program, application user data and the like are stored.

In the embodiment 1, it is supposed that DB data information to be protected, DB process information not to be protected and application A process information not to be protected are stored in the user space 603 and kernel information as a generic term of programs concerning control of the operating system is stored in the kernel space.

In the embodiment 1, information to be protected is defined to be DB data information, although high secret information such as process area of high secret programs and mail information area for a mail server are considered as the information to be protected.

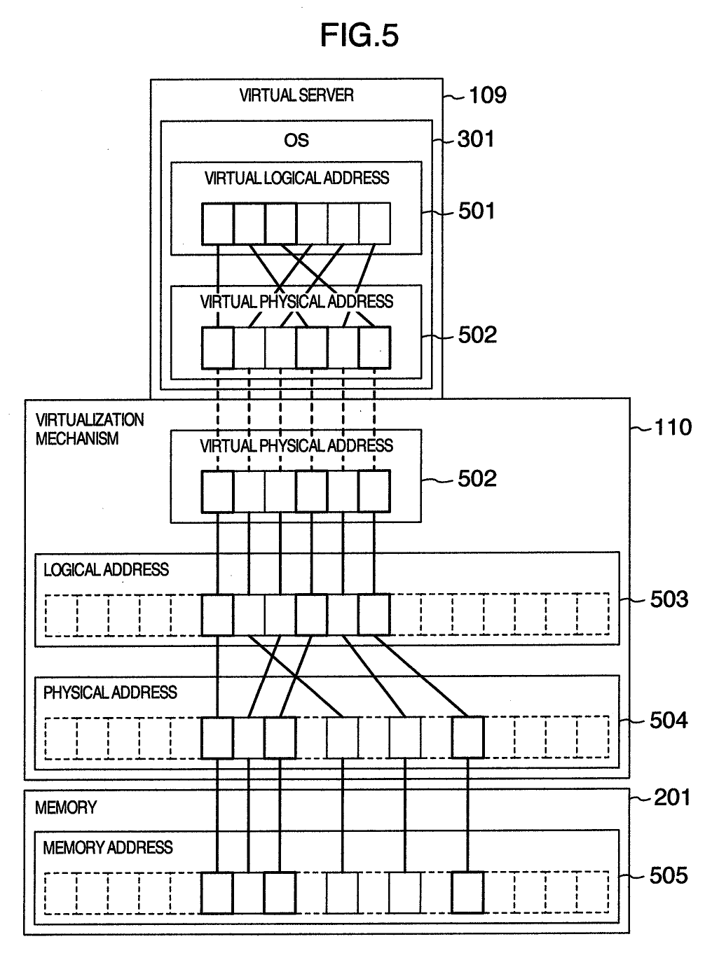

FIG. 5 illustrates a map of memory addresses of the operating system of the virtual server 109 assigned to the virtualization mechanism 110.

FIG. 5 illustrates the memory map of memory addresses 505 assigned to the memory 201, logical addresses 503 and physical addressed 504 assigned to the virtualization mechanism 110 and virtual logical addresses 501 and virtual physical addresses 502 assigned to the operating system 301 of the virtual server 109.

The memory mapping of the virtual logical addresses 501 to the memory addresses 505 is now described by taking a reference instruction to the virtual logical address 501 as an example. When the virtualization server 109 issues the reference instruction to the virtual logical address 501, the operating system 301 converts the virtual logical address 501 into the virtual physical address 502. After conversion, the operating system 301 transmits the virtual physical address 502 to the virtualization mechanism 110. After transmission, the virtualization mechanism 110 converts the virtual physical address 502 into the logical address 503. Then, the virtualization mechanism 110 converts the logical address 503 into the physical address 504. After conversion, the virtualization mechanism 110 transmits the physical address 504 to the memory 201. The memory 201 refers to a value of the transmitted memory address 505.

An example of the mapping situation of the DB data information to be protected in FIG. 6 is shown by thick-line frames in FIG. 5. When the operating system 301 in the virtual server 109 uses the virtual logical address 501 to refer to the DB information, conversion to the virtual logical address, the virtual physical address 502, the logical address 503, the physical address 504 and the memory address 505 can be successively performed to refer to the value thereof.

In the embodiment 1, the virtual physical addresses 502, the logical addresses 503 and the physical addresses 504 are contained in the virtualization mechanism 110, although the method of converting the virtual physical address 502 received from the operating system into the physical address 504 without existence of the logical address 503 is also considered. Further, when the virtualization mechanism 110 detects that the correspondence of the logical addresses 503 and the physical addresses 504 is changed, the virtualization mechanism 110 can utilize the changed correspondence to prepare the address replacement table 108 again. The virtualization mechanism 110 can follow even the change in dynamic logical physical correspondence during execution of the operating system.

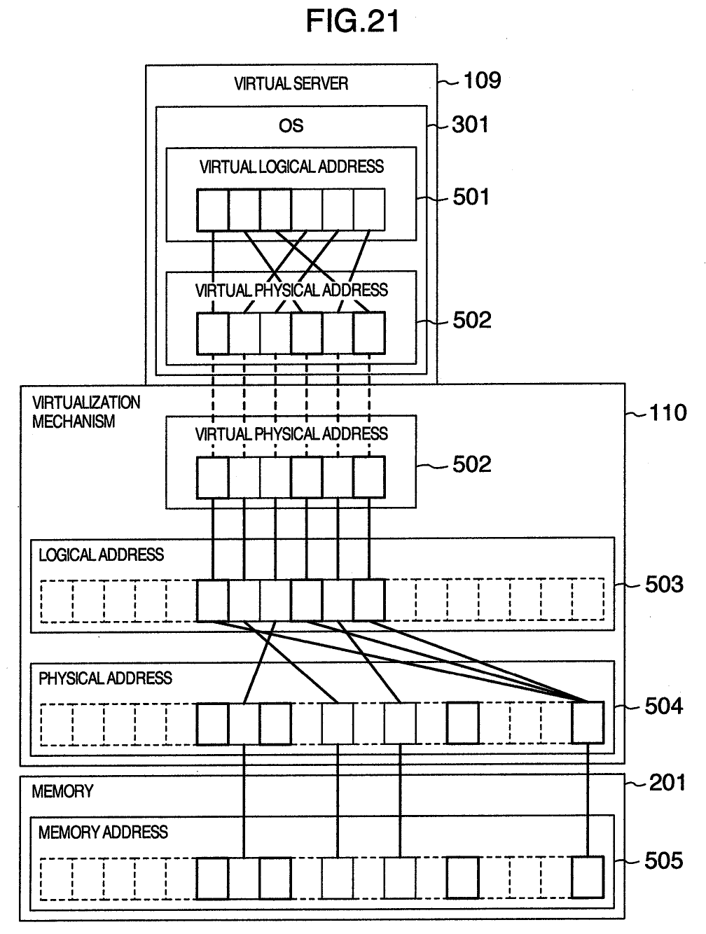

FIG. 21 illustrating a memory map after replacement of the memory address in the virtualization mechanism 110. The mapping situation of the DB information to be protected is shown by thick-line frames in the same manner as in FIG. 5. When the management server 101 prepares the address conversion table 108 in advance and utilizes the memory registration unit 306 of the virtualization mechanism 110 to change the memory map, the reference target of the physical address 504 of the information to be protected is changed to refer to one memory address. A value of the referred memory address is previously changed to a value having no meaning as information such as 0, null and a specific character string, so that reference thereto from the virtual logical address 501 in the operating system can be prevented.

Accordingly, when replacement of the memory address is performed so that the virtual logical address 501 in the operating system is converted into the virtual physical address 502 and the memory address 505 as the dump getting upon occurrence of failure to be outputted, the reference value stored in the changed address is returned as all outputs from the protection area and accordingly the information to be protected can be prevented from being outputted. Moreover, when the changed value is a specified character string such as 0 and null, the compression ratio in the compression processing is increased and an output data size to the external storage medium such as a disk can be reduced. Accordingly, the output time of the disk can be shortened. Consequently, the problem that a write amount to the disk is increased due to the increased capacity of memory and the problem that when all the memory contents are not outputted to the disk in the memory dump processing of the program for getting the memory contents after occurrence of failure, the program is not ended and it takes time to restart the system can be solved.

In the embodiment, as shown in FIG. 21, the reference target of the physical address 504 of the information to be protected is changed to refer to one memory address, although the present invention is not limited to only the embodiment and various methods thereof can be considered.

For example, there are various methods including a method of referring to a memory address of a physical address of information unnecessary to be protected instead of the memory address of the physical address of the information to be protected as in FIG. 21, a method of referring to a memory address of an unused physical address, a method of referring to a memory address of a nonexistent physical address and a method of changing a memory address of a referred physical address at random using random number. In the embodiment, the physical address 504 is used as the address to be replaced, although the method of changing the logical address 503 or the virtual physical address 502 is also considered.

In other words, in the virtualization environment, the address reference portion of the memory information to be protected is changed in accordance with the address conversion table 108, so that the memory information to be protected can be prevented from being leaked out.

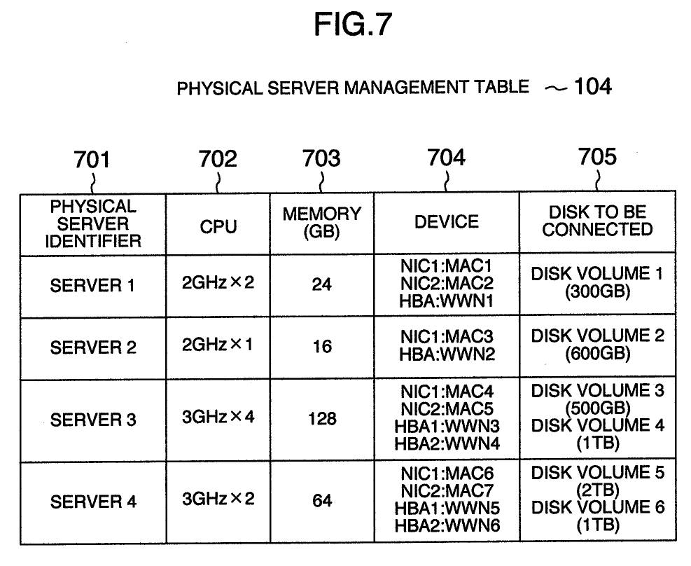

FIG. 7 shows the physical server management table 104. A column 701 stores physical server identifiers. When there are a plurality of physical servers 112, a plurality of pieces of information are stored.

A column 702 stores specifications of CPU (processor). A column 703 stores memory capacity mounted in the physical server 112. A column 704 stores information concerning devices connected to the physical server. For example, when it is NIC (network interface card), MAC address (media access control address) of peculiar identifier and kind are stored and when it is HBC (host bus adapter), WWN (world wide name) is stored. A column 705 stores information concerning a disk to be connected. For example, volume identifier and capacity of the disk volume 114 in the storage apparatus 113 are stored. The disk volume 114 stored therein may be shared with another physical server 112. In this case, the same volume identifier is stored to the physical server 112.

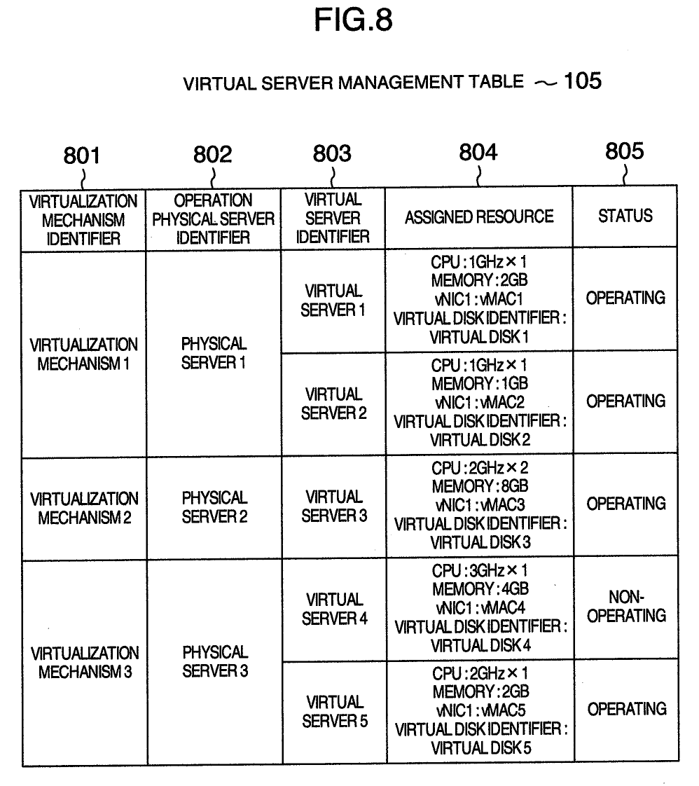

FIG. 8 shows the virtual server management table 105.

A column 801 stores virtualization mechanism identifiers. Usually, one physical server 112 contains one virtualization mechanism 110. A column 802 stores identifiers of physical servers in which the virtualization mechanisms 110 are operated. A column 803 stores virtual server identifiers. The virtual server identifier may be a unique value within the virtualization mechanism 110 or over a plurality of virtualization mechanisms 110.

The number of virtual server identifiers stored in the column 803 is equal to the number of the virtual servers 109 produced in the virtualization mechanism 110.

A column 804 stores resources assigned to the virtual servers 109. For example, the resources include assignment state of CPU, memory capacity, information of NIC, virtual disk identifier and the like.

A column 805 stores the status of the virtual servers 109. For example, the status includes operating, non-operating and the like. The virtual server 109 being operated can be grasped to get a load on the whole physical server easily.

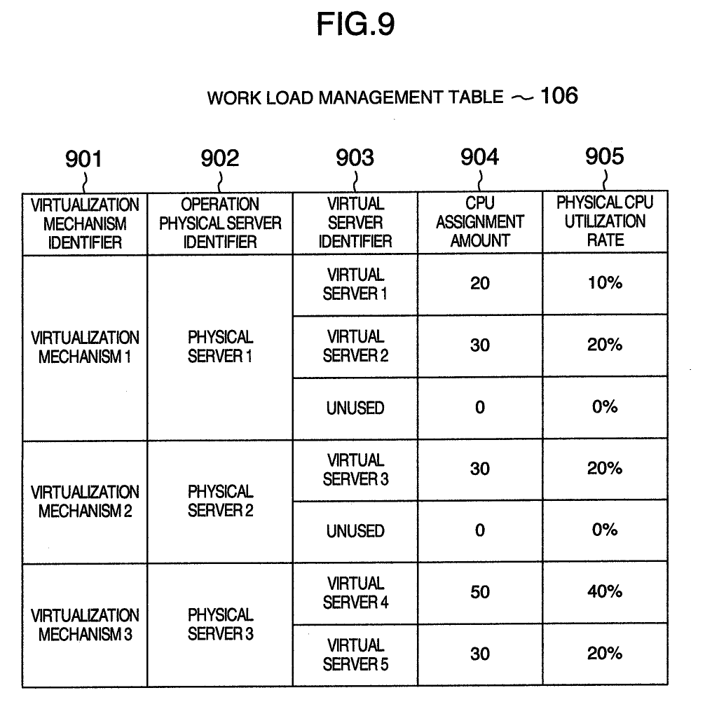

FIG. 9 shows the work load management table 106.

A column 901 stores virtualization mechanism identifiers. A column 902 stores operation physical server identifiers. The operation physical server identifier is an identifier of the physical server 112 in which the virtualization mechanism 110 designated by the virtualization mechanism identifier of the column 901 is operated. When a plurality of virtualization mechanisms 110 are operated in one physical server 112, a plurality of virtualization mechanism identifiers 901 are stored for the operation physical server identifier 902.

A column 903 stores virtual server identifiers. The identifiers of the virtual servers 109 which are produced by the virtualization mechanism identifiers 901 and control the work load are stored therein. All the virtual servers 109 produced by the virtualization mechanism identifier 901 may be stored therein or only the identifiers of the virtual servers 109 which control the work load may be stored therein.

A column 904 stores assignment amount of CPU. The assignment amount of CPU is an amount of CPU assigned to the virtual server 109. As the assignment amount of CPU is increased, the processing performance of the virtual server 109 is improved. The user may designate the unit of the assignment amount of CPU to be any value. For example, the assignment amount of CPU may be set to 100% in total for each of the virtualization mechanism 110 and a value thereof may be stored as an assignment rate for each of the virtual servers 109. Furthermore, it is not necessary to assign all performance of the virtualization mechanism 110 to the virtual servers 109. In order to cope with a suddenly increased load on the virtual server 109, unused part of CPU may be left.

A column 905 stores physical CPU utilization rates. The physical CPU utilization rate is the utilization rate in case where all the processing amount of the CPU 202 for the physical server designated by the physical server identifier 902 is defined to 100%. The physical CPU utilization rate may be calculated from the time scheduled by the virtualization mechanism 110 of the CPU utilization rate for each of the virtual servers 109 or may be calculated by collecting the utilization rate of the virtual server 109 itself and multiply the collected utilization rate by the assignment amount 904 of CPU. The load on the physical server 112 indicated by the operation physical server identifier 902 can be understood on the basis of the physical CPU utilization rate 905.

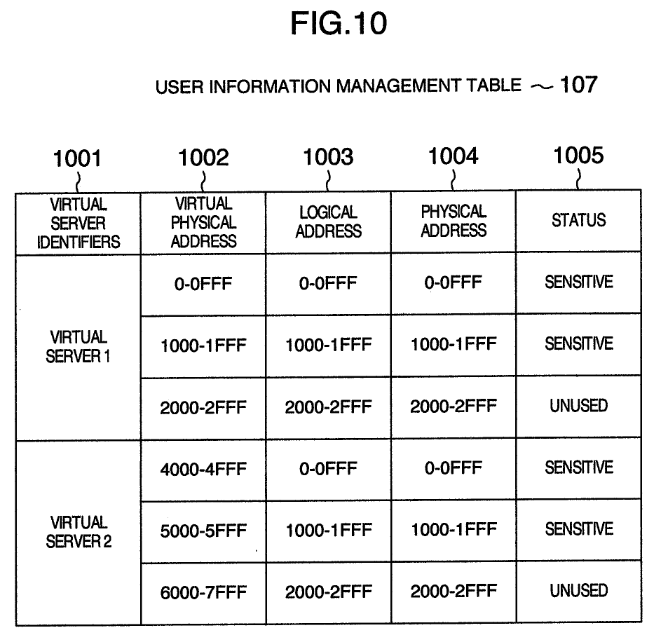

FIG. 10 shows the user information management table 107. The user information management table 107 is prepared for each of the physical servers 112.

A column 1001 stores virtual server identifiers. A column 1002 stores the virtual physical addresses having the same contents as the virtual physical addresses 502 of the OS address map table 308 possessed by the operating system 301 installed in the virtual server 109. A column 1003 stores logical addresses corresponding to the virtual physical addresses stored in the column 1002. A column 1004 stores physical addresses corresponding to logical addresses stored in the column 1003.

A column 1005 stores status. The status represents memory state and supplementary information and values thereof are considered to be nonuse of memory, sensitive and non-sensitive information and the like. The nonuse of memory represents memory in which the virtualization mechanism 110 is not yet assigned to the virtual server 109. The sensitive information represents information desired to be protected and moreover priority and use are added thereto to represent the use situation of memory in detail. The non-sensitive information represents information that is not required to be protected and moreover priority and use are added thereto to represent use situation of memory in detail. The status is used to be able to grasp the utilization rate of memory and discriminate whether information is that to be protected or not.

In the embodiment 1, replacement of the memory is performed without using the user information management table 107, although the table can be utilized to perform detailed information protection and information acquisition using the work load. For example, use of the memory is assigned to the status information and when failure is detected, information acquisition as to whether a related memory area is acquired in accordance with a failure part or not is decided to thereby get failure information effectively. Moreover, the priority order of the failure information is designated and the failure information having the high priority order is considered to be heavy work load so that the failure information is gotten early whereas when the priority order of the failure information is not high, the work load is reduced so that other systems are not influenced and the failure information is gotten, so that the flexibility of the information acquisition can be improved.

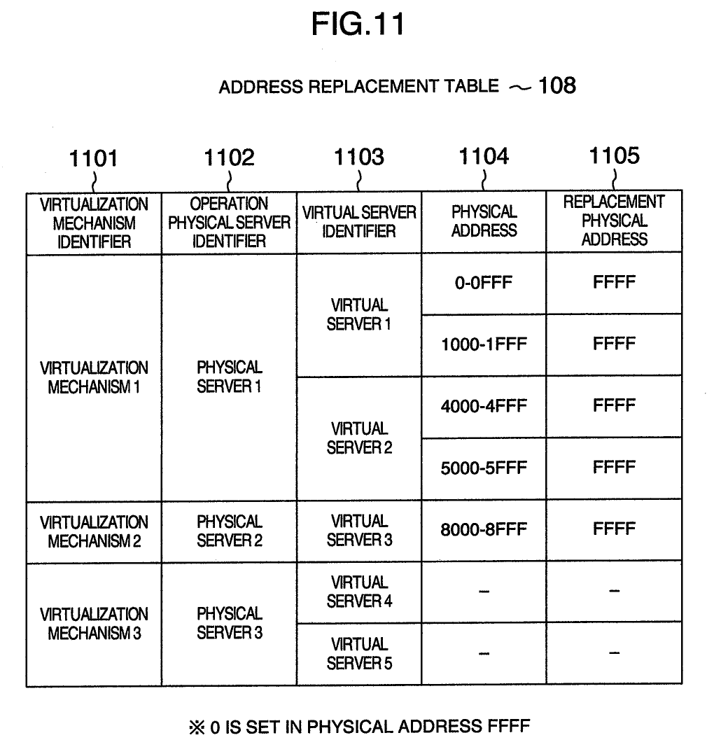

FIG. 11 shows the address replacement table.

A column 1101 stores virtualization mechanism identifiers. A column 1102 stores operation physical server identifiers. A column 1103 stores virtual server identifiers. A column 1104 stores physical addresses. The physical addresses stored in the column 1104 represent the physical addresses 504 corresponding to the virtual logical addresses 501 of the operating system installed in the virtual server in which information to be protected is stored.

A column 1105 stores replacement physical addresses. The replacement physical addresses stored therein represent the physical addresses to be referred to after replacement of the physical address. For example, value 0 is previously set in FFFF of the physical address and FFFF is stored as the replacement physical address. After stored, the physical address registered in the column 1104 is replaced by the replacement physical address, so that the physical address is set to FFFF and accordingly the reference value of the address is 0 and the information desired to be protected can be hidden.

In the embodiment 1, the replacement table is previously prepared by processing of the user information transmission unit and the address replacement management unit and memory replacement is performed on the basis of the prepared information. Consequently, the reference target of the information desired to be protected can be changed to protect information.

Moreover, in the embodiment 1, the address replacement table 108 is prepared and held and the memory information registered in the address replacement table 108 is replaced at any timing to realize protection of information required to be protected, although the function of CPU can be added to realize protection of information without preparing and holding the address replacement table 108. For example, the physical memory is partitioned in a fixed length of 4 kilo-bytes currently, although it is supposed that a special flag for judging a protection area can be set between partitions to be valid or invalid. In this case, when the CPU receives an area ensuring instruction of information to be protected, the flag is made valid for the physical address of the ensured area in the unit of page. Usually, data is read and written without referring to the flag. When it is necessary to protect information, the CPU refers to the flag and when the flag is valid, the CPU returns data having no meaning as the reference result of the page.

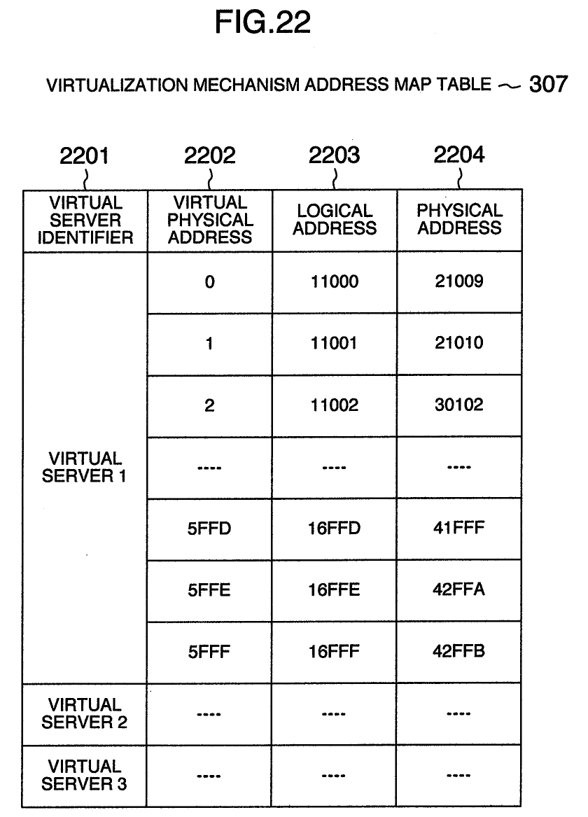

FIG. 22 shows the virtualization mechanism address map table 307.

A column 2201 stores virtual server identifiers. A column 2202 stores virtual physical addresses. The virtual physical addresses stored therein represent the virtual physical addresses 502 of the operating system 301 installed in the virtual server 109. The virtual physical address 502 of the virtualization mechanism address map table 307 is received by the virtualization mechanism 110 from the operating system installed in the virtual server 109 to be stored.

A column 2203 stores logical addresses. The logical addresses stored therein represent addresses in case where the virtual physical address registered in the column 2202 is made to correspond to the memory map of the virtualization mechanism 110.

A column 2204 stores physical addresses. The physical addresses stored therein represent physical addresses corresponding to the logical addresses of the column 2203.

In the embodiment 1, it is supposed that the virtualization mechanism 110 receives the virtual physical address from the operating system installed in the virtual server 109 and makes address conversion and the virtualization mechanism address map table 307 has been prepared.

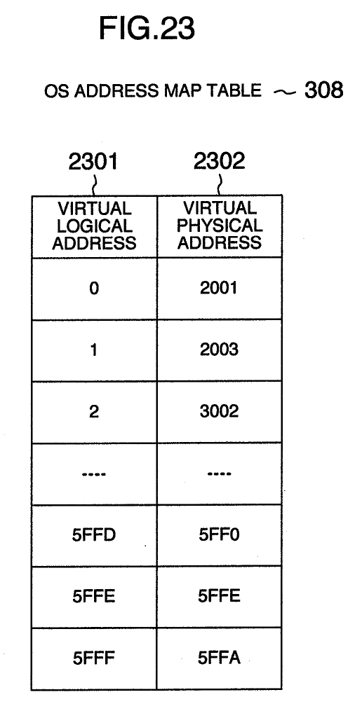

FIG. 23 shows the OS address map table 308.

A column 2301 stores virtual logical addresses. The virtual logical addresses stored therein represent the virtual logical addresses of the operating system installed in the virtual server 109. The virtual logical addresses are recognized as usual logical addresses as viewed from the operating system.

A column 2302 stores the virtual physical addresses. The virtual physical addresses stored therein represent the virtual physical addresses corresponding to the virtual logical addresses registered in the column 2301. The virtual physical addresses are recognized as usual physical addresses as viewed from the operating system.

In the embodiment 1, it is supposed that the OS address map table 308 has been prepared in the operating system installed in the virtual server. The OS address map table 308 is a table in which correspondence of the virtual logical addresses to the virtual physical addresses is managed.

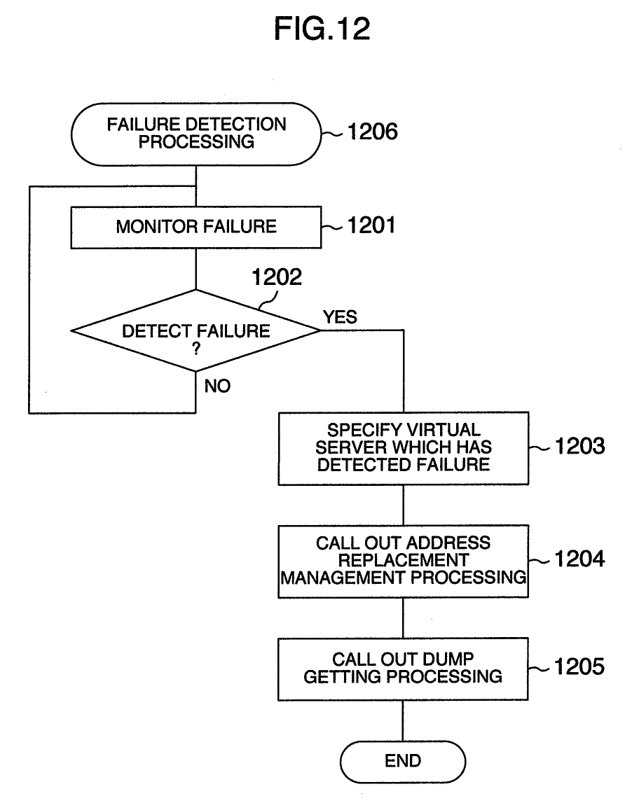

FIG. 12 is a flowchart showing the failure detection processing 1206 performed by the failure detection unit 206. The failure detection processing 1206 detects failure and issues an instruction for replacing the memory in accordance with the address replacement table 108. The failure detection processing 1206 monitors failure of the operating system installed in the virtual server 109 of a target (step 1201). In a concrete example, an address of a failure information getting routine called out from the operating system upon occurrence of failure is gotten and when the failure information getting routine is called out to refer to the address, the virtualization mechanism sets a trap to deprive the operating system of the virtual server of control. When the failure detection processing 1206 ends processing such as memory address conversion in accordance with the address replacement table 108, the failure detection processing returns the control to the routine of getting the failure information such as the dump getting processing 1205.

When failure is not detected, the processing is returned to step 1201 and when failure is detected, the processing proceeds to step 1203 (step 1202). After detection of failure, the virtual server 109 which has detected the failure is specified (step 1203). In a concrete example, the virtual server 109 previously preserves virtual server identifier information defined uniquely in each operating system such as virtual server ID, IP address and MAC address as a table. The failure detection unit receives the virtual server identifier information such as the virtual server ID, the IP address and the MAC address from the virtual server 109 at the timing that it is desired to specify the virtual server and retrieves the virtual server having the virtual server identifier information identical with the contents of the previously prepared table to be specified.

In order to overwrite the memory address of the specified virtual server 109 by the address replacement table 108, the address replacement management processing 1204 is called out (step 1204). When control is returned from the address replacement management processing 1204, it is confirmed that the memory address 505 has been overwritten and the dump getting processing 1205 is called out to get the dump (step 1205).

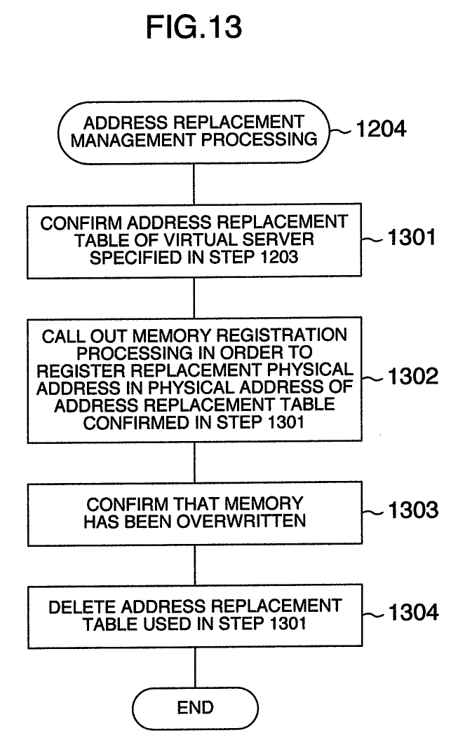

FIG. 13 is a flowchart showing the address replacement management processing 1204 performed by the address replacement management unit 210.

This processing is called out by the failure detection processing 1206 and performs the processing for replacing the memory in accordance with the address replacement table 108 with respect to the virtual server identifier specified before calling out.

When the address replacement management processing 1204 is called out, the virtual server identifier delivered as parameter upon calling out is confirmed. Coincidence of the virtual server identifier delivered as parameter and the virtual server identifier 1103 of the address replacement table 108 is confirmed and the replacement address 1103 and the physical address 1102 of the coincident virtual server identifier 1103 are confirmed (step 1301).

In order to replace the memory, the memory registration processing 1404 which is the processing of the memory registration unit 306 of the virtualization mechanism being operated in the pertinent physical server is called out while using the confirmed virtual server identifier 1101, physical address 1102 and replacement address 1103 as parameters (step 1302).

After control is returned from the memory registration processing 1404, it is confirmed that the processing has been ended normally (step 1303). After confirmation, the address replacement table entry of the replaced virtual server identifier is deleted (step 1304).

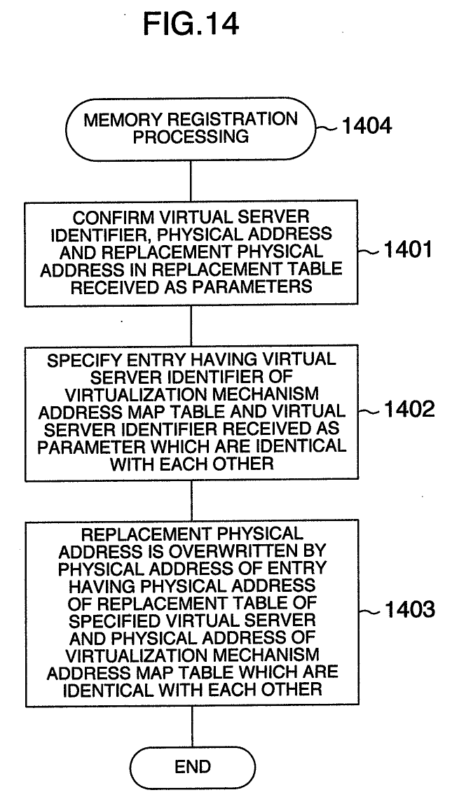

FIG. 14 is a flowchart showing the memory registration processing 1404 performed by the memory registration unit 306.

This processing is called out from the address replacement management processing 1204 and performs the address replacement processing on the basis of the virtual server identifier of the replacement address 1103, the physical address 1102 and the replacement address 1103 received as parameters.

When the memory registration processing 1404 is called out, the virtual server identifier 1101, the physical address 1102 and the replacement address 1103 received as parameters upon calling out are confirmed (step 1401). After confirmation, an entry having the virtual server identifier 1101 received as parameter and the virtual server identifier of the virtualization mechanism address map table 307 which are identical with each other is confirmed (step 1402). After confirmation of the entry, an entry of the physical address 1102 received as parameter and the physical address of the virtualization mechanism address map table which are identical with each other is confirmed responsive to the entry having the identical virtual server identifier and when they are identical with each other, the replacement address 1105 received as parameter is overwritten (step 1402).

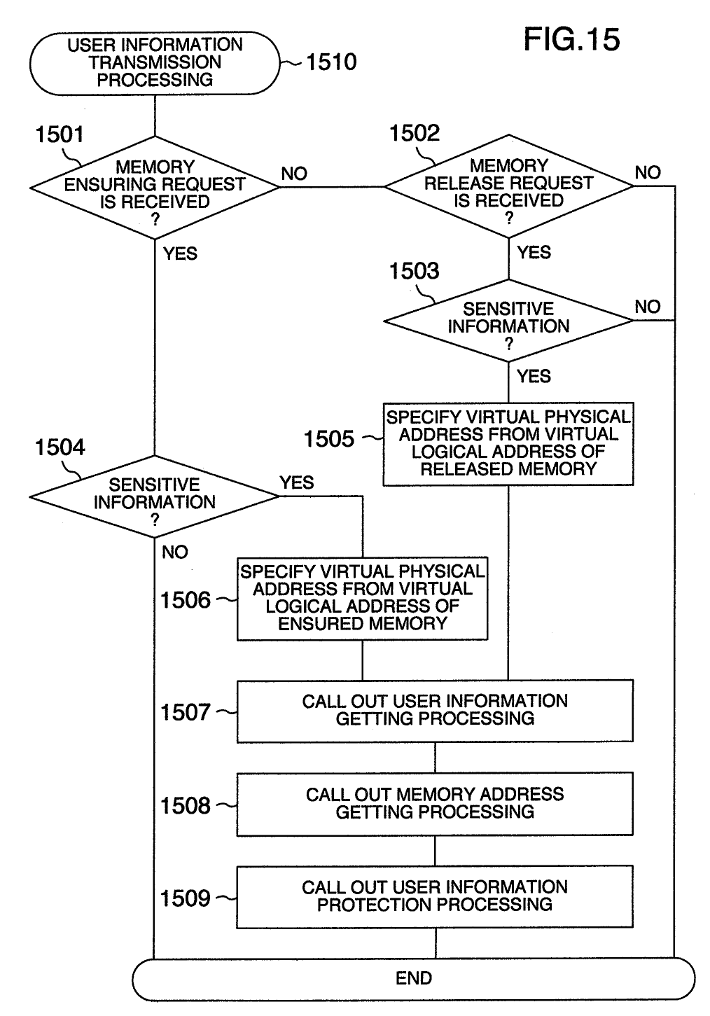

FIG. 15 is a flowchart showing the user information transmission processing 1510 performed by the user information transmission unit 303. This processing performs preparation of the address replacement table 108 necessary for the memory address replacement.

In the user information transmission processing 1510, it is supposed that virtual physical address information of information to be protected is called out from the user or the application as parameter after ensuring the memory area or before releasing the memory area.

As an acquisition example of the virtual physical address information of the information to be protected received in the embodiment, a top address and a size of the virtual logical address 2301 in the OS address map table 308 possessed by the operating system 301 installed in the virtual server 109 are represented. Generally, in ensuring of the memory area, the size is designated together with the memory ensuring instruction and the top address of the virtual logical address 2301 ensured as execution result is returned from the operating system.

When the user information transmission processing 1510 is called out, it is judged whether the memory ensuring request is received or not. When the ensuring request is received, processing proceeds to step 1504 and when the ensuring request is not received, processing proceeds to step 1502 (step 1501).

When the memory ensuring request is received, it is judged whether the address required to be ensured is sensitive information or not. When it is the sensitive information, the processing proceeds to step 1506 and when it is not the sensitive information, the processing is ended (step 1504).

When the memory ensuring request is received and the address is sensitive information, an entry having the virtual logical address 2301 in the OS address map table 308 acquired from the operating system and the virtual logical address of the ensured area which are identical with each other is confirmed and the virtual physical address 2302 associated with the virtual logical address 2301 is specified (step 1506).

After the virtual physical address 2302 is specified, the user information getting processing 1507 is called out while using the specified virtual physical address 2302 as parameter. The user information getting processing 1507 specifies the virtual server 109 which has called out the user information transmission processing 1510 (step 1507).

After the virtual logical server 109 is specified, the memory address getting unit 212 is called out while using the virtual server 109 specified in step 1507 and the virtual physical address 502 delivered in step 1507 as parameters in order to specify the logical address 503 and the physical address 504 corresponding to the virtual physical address 502 (step 1508).

After the memory address getting processing is ended, the user information protection processing 1509 is called out and the physical address 1104 and the replacement physical address 1105 of the pertinent virtual server identifier 1103 in the address replacement table 108 are updated (step 1509).

In judgment of step 1501, when the memory ensuring request is not received, it is judged whether a memory release request is received or not. When the release request is received, the processing proceeds to step 1503 and when the release request is not received, the processing is ended (step 1502).

When the memory release request is received, it is judged whether the address is sensitive information or not. When it is the sensitive information, the processing proceeds to step 1505 and when it is not the sensitive information, the processing is ended (step 1503).

When the memory release request is received and the address is sensitive information, the virtual physical address is specified from the virtual logical address of the released memory and the processing proceeds to step 1507 (step 1505).

In the embodiment 1, the user information transmission unit is called out after ensuring memory or before releasing memory, although the user information transmission unit may be called out at any timing as far as the virtual physical address information of the information to be protected can be specified.

Moreover, as a case where the user information transmission unit of the embodiment 1 is called out, there is considered the case where information having high secrecy as in a user area or process area in which user data in an in-memory database (DB) is stored, a process area of program having high secrecy and a mail information area for a mail server is loaded in the memory.

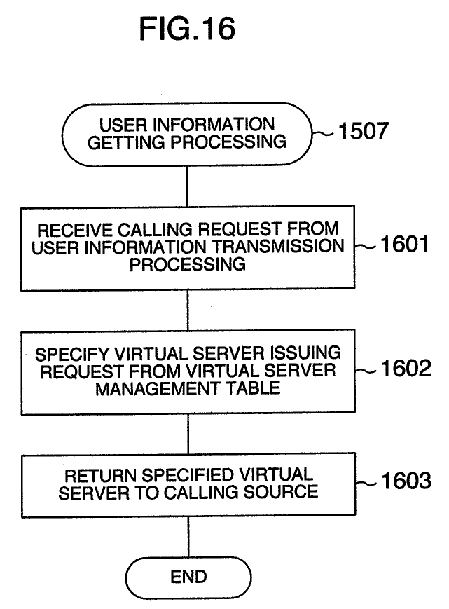

FIG. 16 is a flowchart showing the user information getting processing 1507 performed by the user information getting unit. In this processing, the virtual server identification information 801 in the virtual server management table 105 and the virtual server identification information received as parameter are utilized to specify the virtual server which has issued the information protection request.

The user information getting processing 1507 receives a request from the user information transmission processing 1510 (step 1601). The virtual server 105 having the virtual server identification information 806 in the virtual server management table 105 and the virtual server identification information received as parameter which are identical with each other is confirmed to specify the virtual server 105 (step 1602). The virtual server 105 specified in step 1602 is returned to a calling source (step 1603).

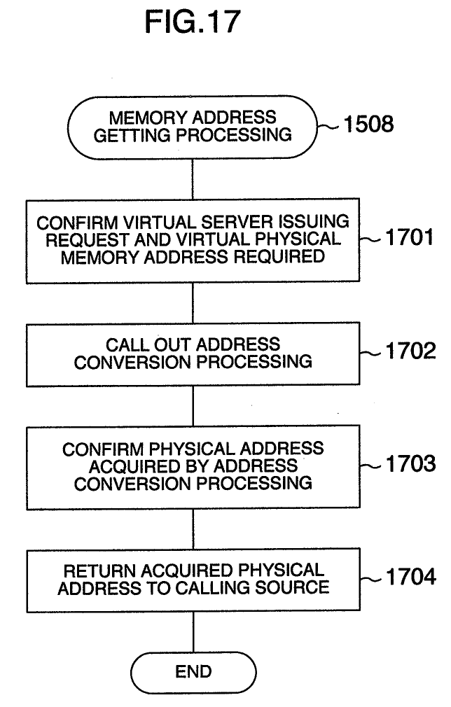

FIG. 17 is a flowchart showing the memory address getting processing 1508 performed by the memory address getting unit 212.

In this processing, the address conversion unit 305 of the virtualization mechanism 110 is called out on the basis of information of the virtual physical address 2302 and the virtual server identifier 803 received as parameter to specify the logical address and the physical address.

The memory address getting processing 1508 confirms the virtual physical address 2302 and the virtual server identifier 803 which has issued the information protection request received as parameter (step 1701). In order to specify the logical address 2203 and the physical address 2204 corresponding to the virtual physical address 2302, the address conversion unit 305 is called out while using the virtual physical address 2302 and the virtual server identifier 803 which has issued the request as parameter (step 1702). When the processing of the address conversion unit 305 is ended, the logical address 2203 and the physical address 2204 gotten by the address conversion unit 305 are confirmed (step 1703).

The logical address 2203 and the physical address 2204 confirmed in step 1703 are returned to the calling source (step 1704).

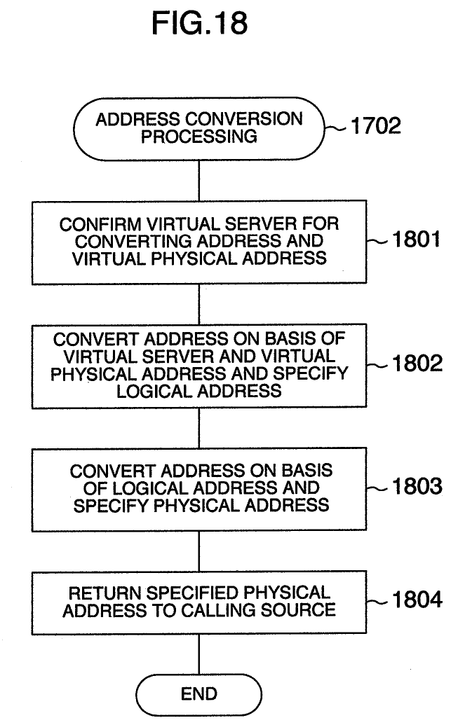

FIG. 18 is a flowchart showing the memory address conversion processing 1702 performed by the address conversion unit 305.

This processing is called out by the memory address getting processing 1508 and specifies the logical address 2203 and the physical address 2204 on the basis of information of the virtual server identifier 803 and the virtual physical address 2302 received as parameters and information in the virtualization mechanism address map table 307.

The address conversion processing 1702 confirms the virtual server identifier 803 and the virtual physical address 2302 received as parameters (step 1801).

The logical address identical with the virtual physical address 2302 confirmed in step 1801 is confirmed (step 1802). The physical address identical with the logical address confirmed in step 1802 is confirmed (step 1803). The results confirmed in steps 1802 and 1803 are returned to the calling source (step 1804).

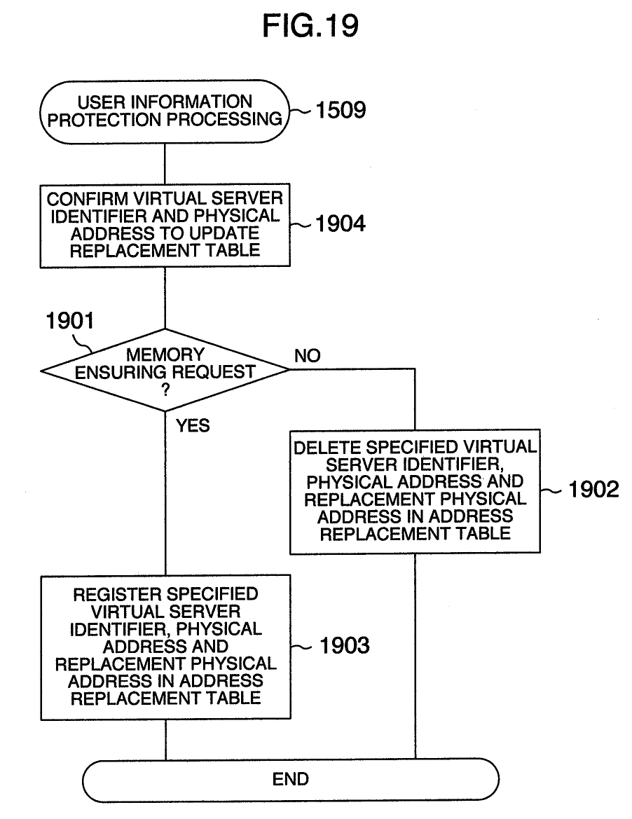

FIG. 19 is a flowchart showing the user information protection processing 1509 performed by the user information protection unit 207.

The user information protection processing 1509 is called out by the user information transmission processing 1510 and prepares or deletes the address replacement table 108 by means of the virtual server identifier 803 and the physical address 2204 received as parameters.

The user information protection processing 1509 confirms the virtual server identifier 803 and the physical address 2204 received as parameters (step 1904).

It is judged whether the memory ensuring request is received in the step of preparing the address replacement table 108 or not. When it is the ensuring request, the processing proceeds to step 1903 and when it is not the ensuring request, the processing proceeds to step 1902 (step 1901).

When it is the ensuring request, the virtual server identifier 803, the physical address 2204 and the replacement physical address 1105 are registered in order to add entry to the address replacement table 108 (step 1903).

When it is not the ensuring request, the entry of the address replacement table 108 having information identical with the virtual server identifier 803 and the physical address 2204 received as parameter and the replacement physical address 1105 is deleted (step 1902).

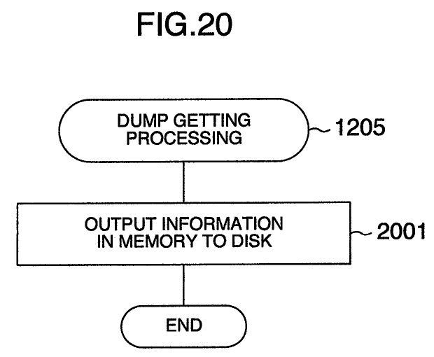

FIG. 20 is a flowchart showing the dump getting processing 1205 performed by the dump getting unit 304.

The dump getting processing 1205 utilizes the function generally possessed by the operating system 301.

When the dump getting processing 1205 is called out, all of the logical addresses 2301 and the physical addresses 2302 corresponding to the logical addresses 2301 in the address map table 308 possessed by the operating system 301 and the memory addresses 505 corresponding to the physical addresses 2302 are outputted into the disk (step 2001).

In the embodiment, the virtual server 109 in which the failure has occurred is restarted after the dump getting processing 1205 is ended, although another method may be considered. There is a method of restarting the virtual server 109 without waiting completion of the dump getting processing 1205 in order to restart the virtual server 109 in which the failure has occurred at higher speed in a shorter time. The virtual server 109 is assigned the user space 603 and the kernel space 604 in the memory 201 as shown in FIG. 6. The dump getting unit 1205 dumps data in the user space 603 and the kernel space 604 selectively, although the virtual server 109 is restarted as leaving the user space 603 and the kernel space 604, so that the dump getting unit 1205 and the virtual server 109 can be restarted in parallel. Concretely, when the memory 201 included in the virtualization mechanism 110 in which the virtual server 109 is operated contains any unoccupied memory which can be assigned at least the user space 603 and the kernel space 604, the unoccupied memory area can be assigned as a new memory area of the virtual server 109. Whether there is any unoccupied memory or not can be decided by calculating the total value of all the virtual servers 109 operated in the virtualization mechanism 801 for memory values of the assignment resources 804 in the virtual server management table 105 and comparing the total value with the capacity 703 of the memory included in the physical server 112 in which the virtualization mechanism 110 is operated. Consequently, the virtual server can be restarted using the newly assigned memory area and the dump getting unit 1205 can be executed in parallel. On the other hand, when a new memory area cannot be assigned to the virtual server 109, a method of executing the virtual server by means of another physical server 112 is also considered. The physical server management table 104 and the virtual server management table 105 can be searched for whether there is the resource which can be assigned the virtual server or not and information of the assignment resource 804 of the virtual server 109 can be transferred to the virtualization mechanism 110 operated in the physical server 112 having the unused resource, so that the virtual server can be produced. Since the execution range of the virtual server 109 can be expanded, the case capable of being executed in parallel with the dump getting unit 1205 can be increased.

In the embodiment 1, the protection of user data upon dump in failure of the virtual server 109 is described, although the user data protection in another case is also considered. It is considered that the user data protection may be performed not only upon dump in failure but also upon temporary stop of the virtual server 109 or upon movement of the virtual server 109 to another physical server 112. The temporary stop of the virtual server 109 is one function of the virtualization mechanism 110 which can make the starting operation fast by stopping the virtual server 109 and storing the user space 603 and kernel space 604 assigned to the virtual server 109 or control information of the processor 202 of the virtual server 109 or control information of the network interface 203 or the disk interface 204 into the disk volume 114 so that the stored information is restored upon starting of the virtual server. The movement of the virtual server 109 to another physical server 112 is the function of transferring the virtual server 109 to another physical server 112 by transferring the user space 603 and the kernel space 604 assigned to the virtual server 109 or control information of the processor 202 of the virtual server 109 or control information of the network interface 203 or the disk interface 204 to another physical server 112 through the network and reconstructing the virtual server in the physical server of the transfer destination on the basis of the transferred data and information. In such a case, there is the possibility that the user data is leaked out by monitoring data flowing through the disk interface or the network since the user data is sent to the outside from the physical server 112. In such a case, the user information management unit 102 of the management server 101 detects a request upon the temporary stop of the virtual server 109 or a movement request between the physical servers 112 and instructs the virtualization mechanism 110 to encrypt the data. Consequently, since the data stored in the disk volume 114 or the data flowing through the network is encrypted, leakage of the data can be prevented.

It is needless to say that the present invention is effective not only upon failure, temporary stop of the virtual server and movement of the virtual server but also the case where an event having the possibility that information is leaked in maintenance occurs.

Furthermore, it is considered that the present invention can be realized by computer programs.

Moreover, in the present invention, the protection method of the memory in the virtualization environment is described, although it is needless to say that the present invention is not limited to the virtualization environment.

Even in the usual computer environment, excluding the virtualization environment, in which the correspondence relation of the memory using the memory addresses is attained, when an event such as failure occurs, the correspondence relation of the memory addresses can be changed by previously defined table before the dump processing, so that the information in the memory required to be protected can be protected.

It should be further understood by those skilled in the art that although the foregoing description has been made on embodiments of the invention, the invention is not limited thereto and various changes and modifications may be made without departing from the spirit of the invention and the scope of the appended claims.

1. A user data protection method in a server apparatus including a management server and a physical server having at least a virtual server and a virtualization mechanism, wherein
the management server includes an address replacement table having correspondence relation of memory addresses of a memory assigned to the virtual server and memory addresses of a memory assigned to the virtualization mechanism which is different from correspondence relation included in the virtualization mechanism and
the user data protection method comprising:
a step of making, when an event occurs in a virtual server, the virtual server send virtual server identifier information for identifying the virtual server to the management server;
a step of making the management server detect the event;
a step of making the management server specify the virtual server in which the event occurs in accordance with the virtual server identifier information when the event is detected;
a step of sending the address replacement table to the virtualization mechanism of the physical server including the specified virtual server when the virtual server is specified; and
a step of changing the correspondence relation of the memory addresses of the specified virtual server and the memory addresses of the virtualization mechanism on the basis of the address replacement table.

2. A user data protection method in a server apparatus according to claim 1, wherein
the address replacement table includes a table in which the memory address of the virtual server is made to correspond to one memory address of the virtualization mechanism, a table in which correspondence of the memory addresses is made so that the memory address of the virtual server is changed to the memory address unused by the virtualization mechanism, a table in which correspondence of the memory addresses is made so that the memory address of the virtual server is changed to nonexistent memory address or a table in which the correspondence relation of the memory addresses of the virtual server and the memory addresses of the virtualization mechanism is changed at random using random numbers.

3. A user data protection method in a server apparatus according to claim 1, wherein
information corresponding to the changed memory address of the virtualization mechanism is 0, null or a special string of characters.

4. A user data protection method in a server apparatus according to claim 1, wherein
the event is failure.

5. A user data protection method in a server apparatus according to claim 1, wherein
the management server includes a user authentication unit and
the user authentication unit judges, when a memory reference request is received from a user, whether the user has authority or not,
the address replacement table being enabled to be referred to and changed when the user has the authority.

6. A user data protection method in a server apparatus according to claim 1, wherein
the change of the correspondence relation of the memory addresses of the virtual server and the memory addresses of the virtualization mechanism means that the correspondence relation of logical addresses and physical addresses of the memory of the virtualization mechanism is changed.

7. A user data protection method in a server apparatus according to claim 1, wherein
the event is temporary stop of the virtual server or movement of the virtual server to another physical server.

8. A user data protection method in a server apparatus according to claim 7, wherein
data stored in a disk volume corresponding to the physical server is encrypted.

9. A user data protection method in a server apparatus according to claim 1, wherein
the management server holds information for identifying use of the memory for each virtual server and judges whether the correspondence relation of the memory addresses of the virtual server and the memory addresses of the virtualization mechanism is changed or not on the basis of the use.

10. A user data protection method according to claim 9, wherein
priority is set to each of uses of the memory and
the management server changes an assignment amount of CPU of the virtual server to the virtualization mechanism in accordance with the priority upon getting of dump of the virtual server.

11. A user data protection method according to claim 1, wherein
the memory assigned to the virtual server is located in a permanently stationed area in an in-memory database (DB).

12. A server apparatus including a management server and a physical server having at least a virtual server and a virtualization mechanism, wherein
the management server includes an address replacement table having correspondence relation of memory addresses of a memory assigned to the virtual server and memory addresses of a memory assigned to the virtualization mechanism which is different from that at usual time and
when an event occurs, the virtual server sends virtual server identification information for identifying the virtual server to the management server,
the management server detecting the event,
the management server specifying the virtual server in which the event occurs in accordance with the virtual server identification information when the event is detected,
the address replacement table being sent to the virtualization mechanism of the physical server including the specified virtual server when the virtual server is specified,
the correspondence relation of the memory addresses of the virtual server and the memory addresses of the virtualization mechanism being changed on the basis of the address replacement table.

13. A server apparatus according to claim 12, wherein
the address replacement table includes a table in which the memory address of the virtual server is made to correspond to one memory address of the virtualization mechanism, a table in which correspondence of the memory addresses is made so that the memory address of the virtual server is changed to the memory address unused by the virtualization mechanism, a table in which correspondence of the memory addresses is made so that the memory address of the virtual server is changed to nonexistent memory address or a table in which the correspondence relation of the memory addresses of the virtual server and the memory addresses of the virtualization mechanism is changed at random using random numbers.

14. A server apparatus according to claim 12, wherein
information corresponding to the changed memory address of the virtualization mechanism is 0, null or a special string of characters.

15. A computer program for making a computer function as a server apparatus including a management server and a physical server having at least a virtual server and a virtualization mechanism, wherein
the management server includes an address replacement table having correspondence relation of memory addresses of a memory assigned to the virtual server and memory addresses of a memory assigned to the virtualization mechanism which is different from that at usual time and
the computer program executes the following:
a step of making, when an event occurs, the virtual server send virtual server identifier information for identifying the virtual server to the management server;
a step of making the management server detect the event;
a step of making the management server specify the virtual server in which the event occurs in accordance with the virtual server identifier information when the event is detected;
a step of sending the address replacement table to the virtualization mechanism of the physical server including the specified virtual server when the virtual server is specified; and
a step of changing the correspondence relation of the memory addresses of the virtual server and the memory addresses of the virtualization mechanism on the basis of the address replacement table.
